(19) United States
(12) Patent Application Publication
(10) Pub. No.: US 2018/0242272 A1
(43) Pub. Date: Aug. 23, 2018

(54) POSITIONING SYSTEM AND DEVICE COMPRISING AN ELECTRONIC INK DISPLAY

(71) Applicant: NIDA TECH SWEDEN AB, Malmo (SE)

(72) Inventor: Håkan DACKEFJORD, ÄLVSJÖ (SE)

(21) Appl. No.: 15/920,511

(22) Filed: Mar. 14, 2018

Related U.S. Application Data
(63) Continuation of application No. PCT/SE2016/050850, filed on Sep. 13, 2016.

(30) Foreign Application Priority Data
Sep. 15, 2015 (SE) 1551181-9

(51) Int. Cl. H04W 64/00

(52) U.S. Cl. CPC H04W 64/00; H04W 52/0229

(57) ABSTRACT

A positioning system comprising a node and a device, a method, a node, and a device thereof wherein the node and device are adapted for wireless communication with each other. The node is configured to transmit a positioning request to the device, receive a position response from the device, and calculate the distance to the device. The node is further adapted to transmit graphic information to the device. The further device comprises an electronic ink display adapted to display said graphic information.

### TECHNICAL FIELD

The present invention relates generally to a positioning system and a device thereof comprising an electronic ink display.

### BACKGROUND ART

Positioning systems and communication systems are well known in prior art and utilized for different purposes both in combination with each other and separately. A common implementation of combination of positioning and communication systems are smartphones with GPS support that are used for navigation and other purposes. There are a multitude of different positioning systems used in the art in addition to the Global Positioning System (GPS), such as GLONASS and other positioning systems using for example Wi-Fi. These systems all have different drawbacks and are therefore implemented based on the need for the specific application area. The application area further affects other factors such as the need for batteries and what an acceptable battery life is. For this reason different products on the market are focused towards specific markets application areas.

Systems such as GPS and GLONASS have reasonably good accuracy, works well outdoors and are global systems allowing for a device to be tracked almost anywhere. The global positioning systems have drawbacks in relation to power consumption and indoor coverage. Systems based on Wi-Fi as present in the prior art have limited range but instead works well in indoor environments.

It is also known in prior art to use combination devices, mostly for navigation, wherein a device comprises both a screen and means for positioning. Typical examples are vehicle navigation systems and smartphones. Furthermore, some examples using displays with electronic ink technologies are presented by the prior art. Electronic ink technology mimics the appearance of ordinary ink on paper, but as a digital display. This technology is used in e.g. e-book readers and have benefits in relation to readability and power consumption.

### SUMMARY OF INVENTION

Known devices used in positioning systems, especially devices used for sending and receiving messages, require a lot of electrical power and feature a multitude of applications, such as e.g. smartphones. Most of these applications are generally not needed for simpler operations such as only sending and receiving a message and/or determining positions. Furthermore, the usability and scalability of such systems are limited both to cost, battery life, and size issues. It would therefore be desirable to create a positioning system that is easier and cheaper to produce and implement. It would furthermore be beneficial if the solution, especially the device, required only a low amount of electrical power to run.

In addition, there is a need for communication systems that utilizes other networks than traditional cell phone networks due to the limited cover both in modern housing and in remote locations. It would further be desirable to enable simple pairing of devices as well as easy communication within such a system.

An object of the present invention is to provide a solution for at least some of the problems as mentioned in the background. It is thereby an object of the present solution to arrange a positioning system with long range and low power consumption which is easy to use and install.

It is further an object of the present invention to provide a tracking system wherein devices are used for tracking objects or individuals, such as children. It is further an object to make it easy to assign a device to a certain object, for example through pairing the device with a node and assigning an association or task to the device.

Thus the solution relates to a positioning system comprising a node and a device adapted for wireless communication with each other. The node is configured to transmit a positioning request to the device, receive a position response from the device, and calculate the distance to the device. The node is further adapted to transmit graphic information to the device. The device comprises an electronic ink display adapted to statically display said graphic information.

It is one advantage with the present solution that the positioning system comprises means for sending and statically displaying graphic information. By displaying the information statically the information is not changed until new information is received or a message for clearing the display is received. This has the effect that even if the battery of the device would be drained the display continues to display the graphic information providing an extra layer of security for the positioning system.

In another embodiment is the electronic ink display adapted to statically display said graphic information until new graphic information is received.

According to an embodiment of a device for use in a positioning system, wherein the device is adapted for wireless communication with a node in the positioning system. The device is further adapted to receive a position request from the node, transmit a position response to the node, and receive graphic information from the node. The device further is adapted to statically display said graphic information on an electronic ink display arranged on the device.

The graphic information can in different embodiments be different forms of image information either illustrating something to be interpreted by a user or illustrating for example an identification code, such as a QR code or EAN code, to be interpreted by a reader, scanner, or camera.

It is one advantage with the present solution that the information is illustrated statically and without consuming electricity. Thereby a device with very limited amount of battery capacity has the ability to enable positioning and presenting/communicating information without needing to be recharged as often as for example a smartphone. Furthermore, such a device is much cheaper both to produce and buy in comparison to other positioning and communication devices.

In one embodiment is the graphic information used to identify the device by illustrating what the device is associated to. For example, one user has multiple devices that are utilized for tracking different things or individuals. As an example, the user has three devices, the first device is arranged with a watch strap at the wrist of the user's child playing in the yard, the second device is hidden in the user's car, and the third device is arranged in a neckless carried by the family's dog. The user bought three identical devices with electronic ink displays and positioning means. Through initiating an installation process the user paired each of the devices with a node, preferably the same node, through, for example, photographing a unique identification code. Each of the devices responded by showing an image of the intended use, such as a car, on the electronic ink display. In one embodiment are different software functions activated based on the selected application area. The user can thereby use the positioning devices for different purposes although the hardware is the same. The electronic ink display provides additional features such as sending a message to the second device arranged on the child's wrist indicating that it for example is time for dinner. If the dog gets lost a QR code comprising information about the name of the dog, its home address, and contact details to the owners can be presented on the electronic ink display in addition to the positioning feature. In one embodiment is the positioning feature only available to the owner. In another embodiment is it possible to link QR code displayed on the electronic ink display to a taxi service. A person whom identifies a lost item, child, or pet, scans the QR code and a taxi is automatically ordered to the position of the device. The home address of the item is only displayed to the taxi company and the cost is charged directly on a predetermined account associated with the device.

In one embodiment is the electronic ink display used to recover items when the device has ran out of battery by automatically presenting a QR code comprising all the necessary information to return the item as soon as the battery is indicated as low by the device.

In prior art, some application areas that now can use the energy efficient device as disclosed herein, requires a smartphone or a similar device which consumes high amounts of power. Thereby has the application areas previously been limited. For example, sometimes it is necessary to implement a device that shall last for at least a year without charging the batteries which previously wasn't possible.

Through enabling that the node communicates the graphic information to the display, sends requests, and conducts all calculations and creation of graphics the device can be active for a long time without consuming almost any energy enabling long lasting battery life from small batteries.

According to an embodiment is the wireless communication conducted in a frequency range between 300 and 1000 MHz.

It is another advantage with the present solution that the wireless communication within the positioning system can be conducted in a frequency range between 300 and 1000 MHz. The low frequencies in comparison to conventional mobile communication networks enables that information can be transmitted with low power over long distances.

According to an embodiment the device is adapted to be in a power save mode until any one of a positioning request and graphic information is received from the node.

According to an embodiment the device is adapted to receive input from a user indicating that the user has seen the graphic information and transmit an acknowledgement to the node.

According to an embodiment the input from the user comprises shaking the device.

According to an embodiment the graphic information comprises an identification code. The identification code can for example be an EAN code, GS1 code, QR code, or any other form of identification code.

According to an embodiment the graphic information is used to pair the device with the node.

According to an embodiment the device is associated to at least a second device.

According to an embodiment the electronic ink display of the device is adapted to only consume electricity when changing the displayed graphic information.

According to an aspect of node for use in a positioning system, the node is adapted for wireless communication with a device in the positioning system. The node is further adapted to transmit a position request to the device, receive a position response from the device, calculate the distance to the device, and transmit graphic information to a device. The node is further adapted to enable the graphic information to be statically displayed on an electronic ink display arranged on the device.

It is one advantage with the present solution that all computations are conducted in the node. The device can thereby be passive until a positioning request or graphic information is received. Upon receiving a positioning request the device merely respond with a position response and upon receive graphic information the device merely shows the information on the electronic ink display. Thereby is the novel device as described herein, and the system thereof, enabling low power usage without compromising the overall functionality of the system. This is enabled through conducting all the power consuming operations in the node.

According to an embodiment of the node the wireless communication is within a frequency range between 300 and 1000 MHz.

According to an embodiment the node further is configured to determine the position of the device.

According to an embodiment of the node the graphic information comprises an identification code, wherein said identification code is any one of a QR code, GS1 code, or EAN code.

According to an embodiment of the node the graphic information is used to pair the device with the node.

According to an embodiment the node determines if the device is within a predetermined signal strength threshold for data communication and within a predetermined signal strength threshold for positioning.

According to an embodiment the node sends graphic information that contains a warning if the device is beyond a predetermined signal strength threshold for positioning but within a predetermined signal strength threshold for data communication.

According to an embodiment the node is adapted to transmit a wake up message to the device prior to sending the position request or the graphic information to the device.

According to an aspect performed in a device in a positioning system the device is adapted for wireless communication with a node in the positioning system, and;
receiving a position request from the node,
transmitting a position response to the node,
receiving graphic information from the node, and
statically displaying said graphic information on an electronic ink display arranged on the device.

According to an aspect performed in a node in a positioning system the node is adapted for wireless communication with a device in the positioning system, and
transmitting a position request to the device,
receiving a position response from the device,
calculating the distance to the device,
transmitting graphic information to the device, and
adapting said graphic information to be statically displayed on an electronic ink display arranged on the device.

According to an aspect of a computer program for use in a node, comprising computer readable code means which when executed causes the node to
transmitting a position request to the device,
receiving a position response from the device,
calculating the distance to the device,
transmitting graphic information to the device, and
adapting said graphic information to be statically displayed on an electronic ink display arranged on the device.

According to an aspect of a computer program for use in a device, comprising computer readable code means which when executed causes the device to
receiving a position request from the node,
transmitting a position response to the node,
receiving graphic information from the node, and
statically displaying said graphic information on an electronic ink display arranged on the device.

In one embodiment is the electronic ink display adapted to statically display said graphic information until a user has acknowledge that the information has been received and read.

According to an embodiment the wireless communication in the positioning system is communication in a frequency range between 300 and 1000 MHz.

According to an embodiment of the positioning system the graphic information is used to pair the device with the node.

It is one advantage of the present solution that the electronic ink display can be used to pair and/or activate the device. In one embodiment is the device shipped with an identification code, such as a QR code, already displayed on the electronic ink display. The user scans the code with a node and the node transmits a positioning request or some graphic information that activates the device.

In one embodiment is the identification code used for pairing the device to the node, or to a specific user's cluster of devices.

According to an embodiment, the transmission of an acknowledgement is conducted automatically and with a standard reply based on that the message has been received and thereby only constitutes a “read” confirmation.

According to an embodiment a camera, scanner, or similar is used to scan the graphic information and pair the device with the node. The unit used for scanning the graphic information can be either part of the node or a separate unit connected thereto.

According to an embodiment of the device the electronic ink display only consumes electricity when changing the displayed graphic information.

According to an embodiment the device is associated to at least a second device.

It is one advantage with the present solution that device can be paired to each other through associating them with each other. The association and pairing of the device are conducted for example through the node and enables that multiple device can be used to track the same item. In one embodiment is the item a vehicle and the user installs a random number of devices in the vehicle and pairs them with the node. In so doing it is impossible for someone trying to steal the vehicle to know if they have removed all the tracking devices or not.

The term statically displayed as used herein refers to that the information is displayed constantly on the electronic ink display until a new event occurs, such as receiving new information or acknowledgement by a user.

According to an embodiment the node is adapted to transmit a wake up message to the device prior of sending any one of a position request and graphic information to the device.

According to an aspect in a device in a positioning system the device is adapted for wireless communication with a node. The device comprises a processor, a memory, and a display, and is further adapted to
receiving a position request from the node,
transmitting a position response to the node, and
receiving graphic information from the node.

The display is an electronic ink display operatively coupled to said processor and the device is adapted to statically display said graphic information on the electronic ink display.

According to an aspect in a node in a positioning system the node is adapted for wireless communication with a device. The node comprises a processor, and a memory, the node is further adapted to
transmitting a position request to the device,
receiving a position response from the device,
calculating the distance to the device, and transmit graphic information to a device.

The graphic information is adapted to be statically displayed on an electronic ink display arranged on the device.

According to an aspect a computer program, comprising computer readable code means, which when executed in a node causes the node to perform the solution in accordance with the aspects as described above.

A computer program, comprising computer readable code means, which when executed in a device causes the device to perform the solution in accordance with the aspects as described above.

For the purpose of the disclosure herein and appended claims the device can be any form of device adapted to be tracked by a node including but not limited to a device such as a tag, puck, or any other form of compact device. In one embodiment the device is a tag adapted to host a long life battery with low capacity. The long life battery is adapted to provide the device with energy for a long time lasting through low energy consumption by the device. It is thereby one advantage that the device can be in a sleep mode almost all the time except for when a position request is received comprising a request to wake up the device.

The node can be any form of node, such as a tablet, PDA, smartphone, personal computer, or any other form of suitable node.

### BRIEF DESCRIPTION OF DRAWINGS

The invention is now described, by way of example, with reference to the accompanying drawings, in which:

FIG. 1 illustrates an embodiment of a positioning system comprising a device and a node.

FIG. 2 shows an illustrative embodiment of a device and a node with at least some of their components.

FIG. 3 illustrates a node, a device, and a procedure for pairing/assigning a device.

FIG. 4 illustrates a paired/assigned device.

FIG. 5 illustrates one embodiment of a device comprising an additional communication module.

FIG. 6 illustrates a positioning system comprising multiple devices.

FIG. 7 illustrates a schematic view of the communication between the node and the device.

### DESCRIPTION OF EMBODIMENTS

In the following, a detailed description of the different embodiments of the solution is disclosed with reference to the accompanying drawings. All examples herein should be seen as part of the general description and are therefore possible to combine in any way in general terms. Individual features of the various embodiments and methods may be combined or exchanged unless such combination or exchange is clearly contradictory to the overall function of the implementation.

Briefly described, the solution relates to a system, node and device for enabling simple and easy communication, assignment/pairing, and positioning within a positioning system. The solution utilizes the technology of electronic ink in order to achieve devices comprising displays that require very little electrical energy to run and a positioning technology with low power consumption in order to reduce the battery needed in the device. The displays require no electrical power to maintain the presentation of graphic information, i.e. present the information statically. Electrical power is only required when the electronic ink display changes its presentation of information. The solution is intended to be cheap and easy to implement and use. Thus it does not incorporate all the functionality of devices commonly used in positioning systems, such as e.g. smartphones but instead utilizes a unique and inventive positioning technology together with a unique pairing/assignment/communication system.

The present solution is intended to provide a way to communicate, assigning tasks, and pairing between nodes and devices comprising electronic ink displays. A node is wirelessly connected to at least one device, and the node is adapted to request a position from the at least one device, receive a position response, calculate the distance to the device, and send a message comprising graphic information to the device. The device in turn comprises an electronic ink display as mentioned and a processor operatively coupled to the electronic ink display. The device is adapted to receive a position request from the node, send a position response to the node, display graphic information, and to receive a message comprising graphic information from the node.

An example of one implementation of a solution according to the present disclosure will now be described for illustrative purposes. Imagine a parent wanting to communicate with his/her child. Depending on the age of the child, a smartphone may not be appropriate, for instance due to limited battery capacity and the all the additional functionalities that are available, and/or it may be too expensive. Furthermore, in many situation it is beneficial for a parent to have the possibility of positioning the child without the child needing to have a device, such as a phone, that requires charging often. The most important part is that the parent is able to position and convey messages to his/her child, but it is also important to receive an acknowledgement that the child has seen the message.

With the present solution, the parent could give the child a wristband or watch, i.e. a device, comprising an electronic ink display, which acts as the device in this example, the wristband being operatively connected to a home computer or the parent's smartphone, which acts as the node in this example. The device could also be a tag implemented in a jacket, bag, teddy bear, or any other accessory the child wears or carries around. The parent would have access to the geographic position of the child (more specifically the device) at will, through requesting the position via the node. Also, the parent could use the node to send simple messages to the child, such as a picture of a plate to signal that it is time for dinner, or a picture of a watch to indicate that the time is getting late. It would then be possible for the child to acknowledge receipt of the message, for instance by shaking the device, and this acknowledgment would then be communicated from the wristband to the home computer, so that the parent could also know that the child has seen the message.

The device is a passive device not transmitting its position unless it is requested by an authorized/assigned/paired node. This has many benefits such as extended battery life and smaller size. Furthermore, the device when passive can't be detected by a bug sweeper.

The above example is intended to illustrate the inventive concept and to show one way it could be used. It should be understood that the above example is merely one of many different embodiments of the invention.

The present disclosure utilizes the technology of electronic ink (also called electronic paper, e-ink or e-paper) in order to achieve a configurable display that is very energy efficient and does not require electrical power to maintain the display of graphic information. This functionality may be achieved in different ways, for example by having a layer of electronic ink disposed on top of the display. The layer of electronic ink may in turn comprise multiple layers, wherein different layers fulfill different desired functions of the electronic ink, but for the purpose of this disclosure it will be referred to as a single layer.

The electronic ink layer may comprise electronic ink disposed on a suitable support structure, such as on or between one or multiple electrodes. As used herein, the term electronic ink is meant as a configurable layer mimicking the appearance of ink on paper, which is configurable to display various graphic information and which does not require electrical power to maintain the display of graphic information. One way of achieving this is through a printable conductive layer of ink that has an arrangement of particles or microscopic containers or microcapsules, which achieves a layer of electronic ink that can be manipulated to display graphic information. Each such particle or capsule has an electrophoretic composition of a fluid, such as a dielectric or emulsion fluid, and a suspension of colored or charged particles or colloidal material.

The electronic ink layer may be configured such that that the ink is seen as a single color, such as black, or it may be configured such that the electronic ink can display a spectrum of colors, such as black, white, clear, and it may also be fluorescent, iridescent, bioluminescent, incandescent, ultraviolet, infrared, and/or it may include a material that radiates or absorbs specific wavelengths.

The invention will now be described in more detail with reference to the accompanying drawings.

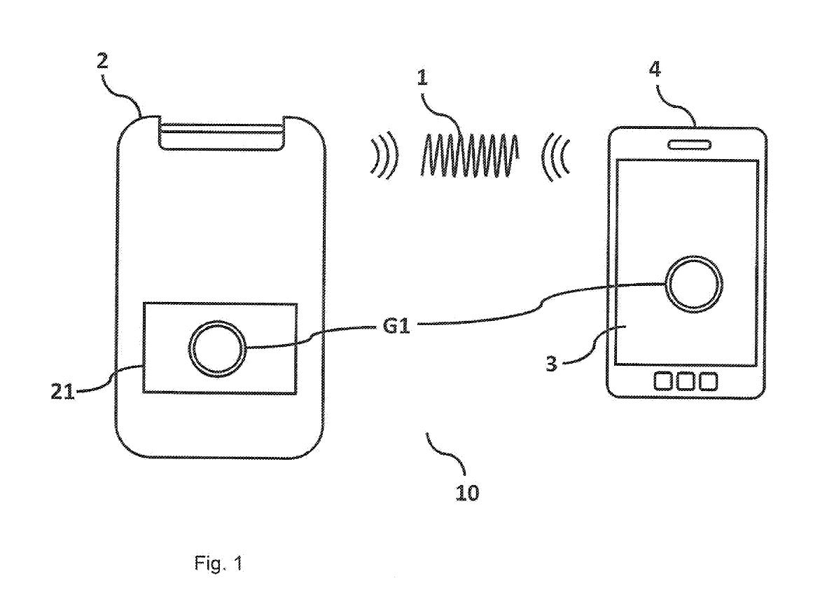

FIG. 1 illustrates a node 4 and a device 2 in a positioning system 10 wherein the node 4 and device 2 communicates wirelessly 1 with each other. The node 4 is in one embodiment a smartphone 4 or any other form of device, such as a personal computer, PDA, or tablet, and comprises an interface 3 for requesting and showing the position of at least one device 2. The interface 3 further is adapted to send graphic information G1 to a display 21 present on the device 2. The display 21 on the device 2 is an electronic ink display that is adapted to only consume power when the graphic information is changed.

FIG. 1 further illustrates an embodiment as described above wherein a graphic information G1 is sent from the node 4 to the device 2, in this specific embodiment the graphic information G1 is an illustration of a plate. The person skilled in the art understands that the graphic information G1 can be any form of graphic information, such as any image or identification code.

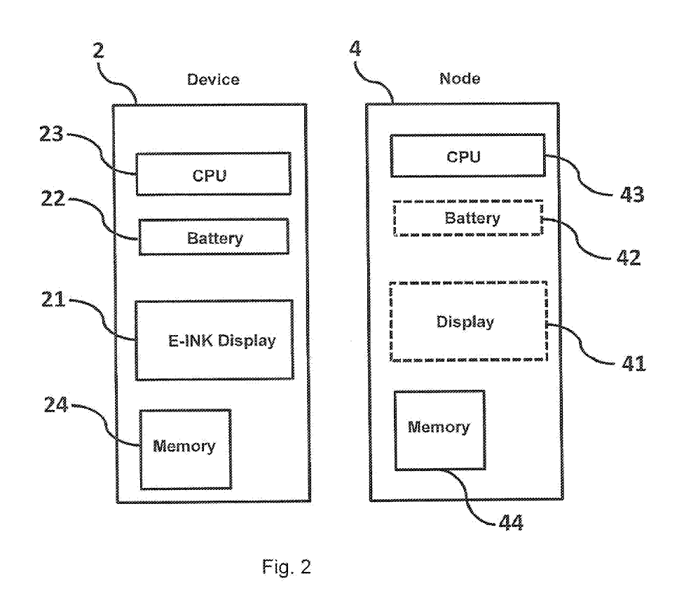

FIG. 2 shows an illustration of some components in a device 2 and in a node 4. The device 2 comprises a CPU 23, central processing unit, a battery 22, an electronic ink display 21, and a memory 24. The memory 24 can be any form of memory 24 but preferably a random access memory.

The node 4 comprises a CPU 43, central processing unit, a battery 42, a display 41, and a memory 44. The display 41 of the node 4 can be any form of display 41, not limited to an electronic ink display. The memory 44 can be any form of memory 44 but preferably a random access memory.

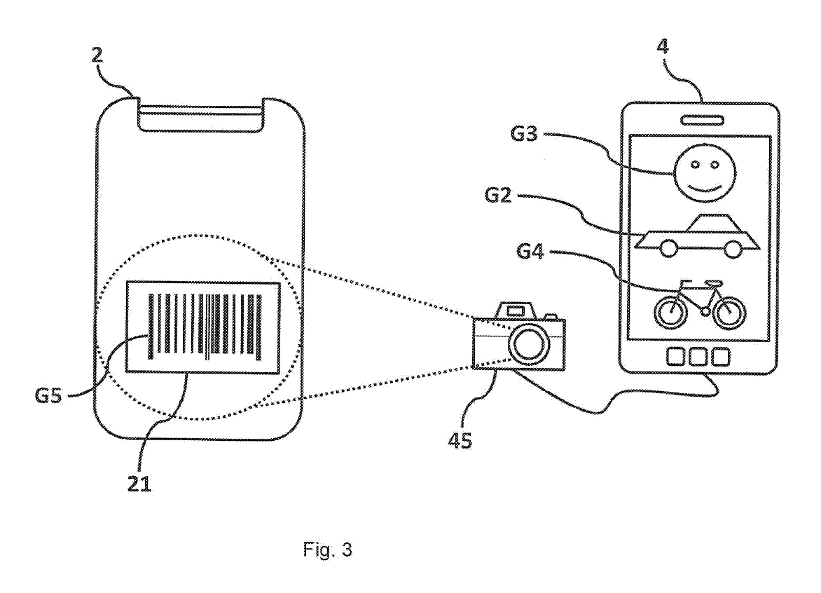

FIG. 3 illustrates one a device 2 and a node 4 wherein the node 4 uses a scanner, camera, or any similar input device to identify the device 2. The device 2 displays an identification code G5, such as a bar code, EAN code, QR code, or any other form of identification code, on the electronic ink display 21. The node 4 uses a scanning device 45 that either is attached to the node 4 or an embedded part of the node 4 to scan the identification code G5.

In one embodiment as shown in FIG. 3 is the identification code G5 used to pair the device 2 with the node 4 or with a cluster of devices 2.

In one embodiment as shown in FIG. 3 the user gets the option to select a graphic information G2, G3, G4 that represents the use of the device 2 after scanning the identification code G5 of the device 2. The graphic information G2, G3, G4 is thereafter shown on the electronic ink display 21, and/or displayed at the node 4 whenever the device 2 is accessed, searched for, or transmitted a message to.

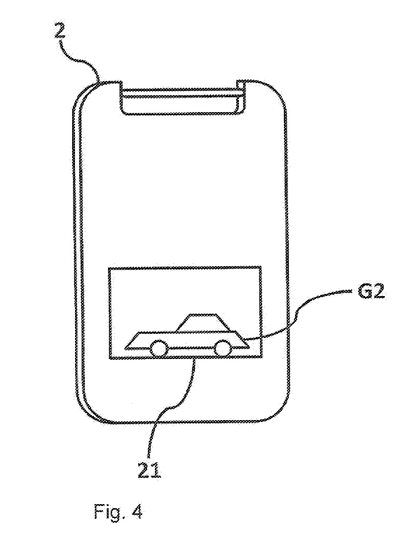

FIG. 4 illustrates a device 2 which has been associated to a vehicle and thereby the graphic information G2 showing a vehicle is displayed on the electronic ink display 21.

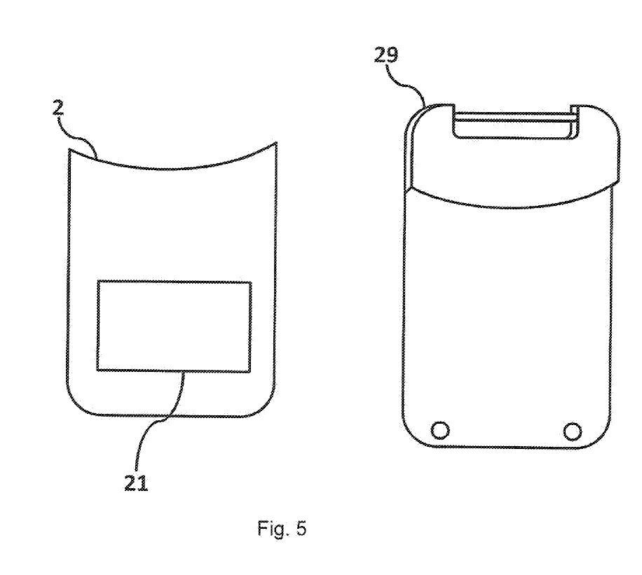

FIG. 5 illustrates an embodiment of the device 2 wherein the device 2 comprises additional communication means 29. The additional communication means 29 can for example be a GSM/3G/LTE enabled device or any other form of extra communication means and arranged as a module attachable to said device 2.

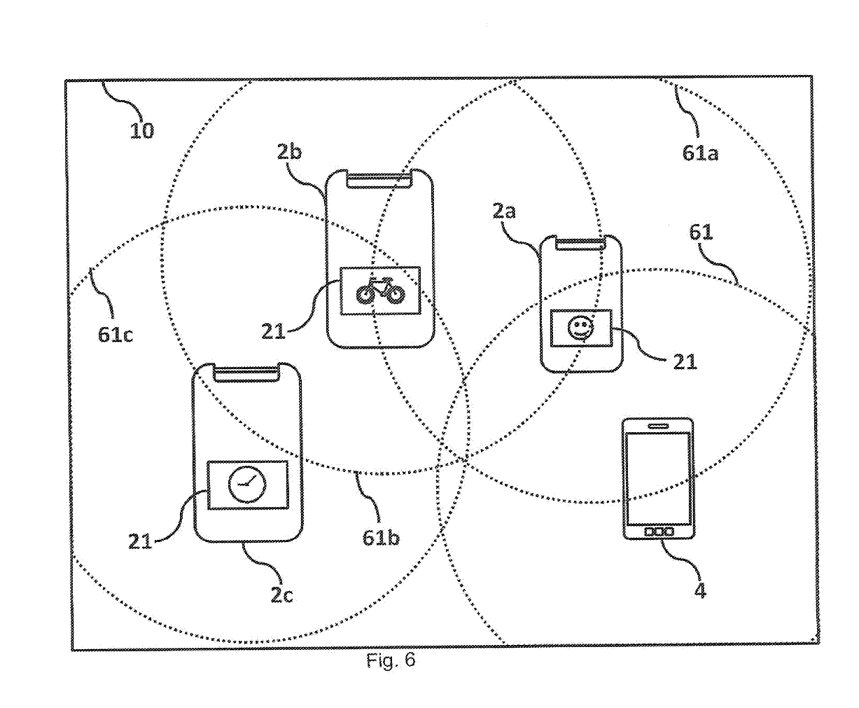

FIG. 6 illustrates a node 4 and multiple devices 2 arranged in a positioning network 10. The positioning and communication network 10 is in one embodiment constituted of multiple devices 2 and nodes 4 that together builds a distributed network. In one embodiment is the positioning and communication network 10 constituted of devices 2, nodes 4, and base stations adapted to communicate through the frequencies as described herein, and/or Bluetooth, Wi-Fi, GSM, 3G, LTE, or any other suitable communication frequency/protocol.

FIG. 6 further illustrates a node 4 that has a first coverage area 61. The first coverage area 61 is a distance around the node 4 where its communication can reach. If the node 4 sends a positioning request or graphic information to a first device 2a that is within the first coverage area 61 the information is transmitted directly to the first device 2a. The first device 2a has its own coverage area 61a covering a distance around the first device 2a. If the node 4 instead transmits a positioning request or graphic information to a third device 2c the information is transmitted via the first device 2a which is within the first coverage area 61, through the second device 2b in the coverage area 61a of the first device 2a, to the third device 2c which is within the coverage area 61b of the second device 2b.

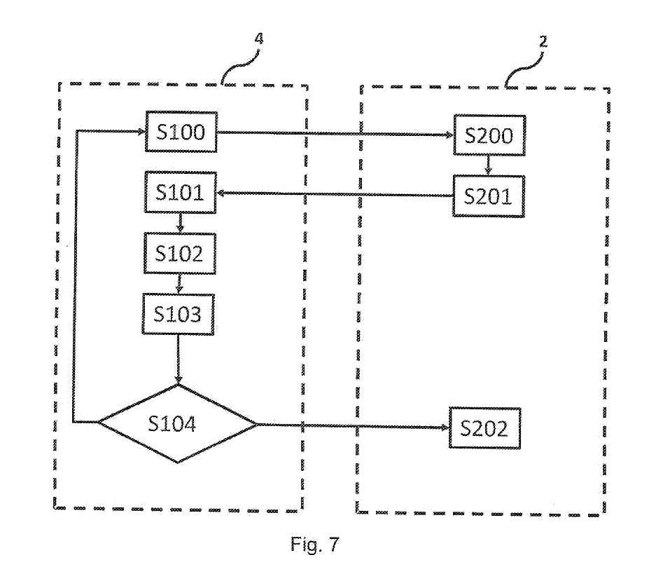

FIG. 7 illustrates a schematic view of a node 4 and a device 2 wherein the node 4 transmits a positioning request S100 to the device 2, the device 2 receives the positioning request S200 and transmits a positioning response S201. The positioning response do not comprise any positioning information. The device 2 do not conduct any calculations more than the required computations for responding to the position request. The positioning response S201 is received S101 by the node 4 and the node 4 calculates S102 the distance to the device 2. The node 4 is further adapted to adapting S103 graphic information to be displayed on an electronic ink display 21. In one embodiment is the node further adapted to determining the positioning of the device 2. The node 4 transmits S104 a message comprising graphic information G1, G2, G3, G4 to the device 2 which receives the message S202.

1. A device for use in a positioning system, wherein the device is adapted for wireless communication with a node in the positioning system, the device is further adapted to receive a position request from the node, transmit a position response to the node, and receive graphic information from the node, wherein the device further is adapted to statically display said graphic information on an electronic ink display arranged on the device.

2. The device according to claim 1, wherein the wireless communication is communication in a frequency range between 300 and 1000 MHz.

3. The device according to claim 1, wherein the device is adapted to be in a power save mode until any one of a positioning request and graphic information is received from the node.

4. The device according to claim 3, wherein the device is adapted to receive input from a user indicating that the user has seen the graphic information and transmit an acknowledgement to the node.

5. The device according to claim 1, wherein the input from the user comprises shaking the device.

6. The device according to claim 1, wherein the graphic information comprises an identification code.

7. The device according to claim 1, wherein the graphic information is used to pair the device with the node.

8. The device according to claim 1, wherein the device is associated to at least a second device.

9. The device according to claim 1, wherein the electronic ink display is adapted to only consume electricity when changing the displayed graphic information.

10. A node for use in a positioning system, wherein the node is adapted for wireless communication with a device in the positioning system, the node is further adapted to transmit a position request to the device, receive a position response from the device, calculate the distance to the device, and transmit graphic information to a device, wherein the node is adapted to enable the graphic information to be statically displayed on an electronic ink display arranged on the device.

11. The node according to claim 10, wherein the wireless communication is communication in a frequency range between 300 and 1000 MHz.

12. The node according to claim 10, wherein the node further is configured to determine the position of the device.

13. The node according to claim 10, wherein the graphic information comprises an identification code, wherein said identification code is any one of a QR code, GS1 code, or EAN code.

14. The node according to claim 10, wherein the graphic information is used to pair the device with the node.

15. The node according to claim 10, wherein the node determines if the device is within a predetermined signal strength threshold for data communication and within a predetermined signal strength threshold for positioning.

16. The node according to claim 15, wherein the node sends graphic information that contains a warning if the device is beyond a predetermined signal strength threshold for positioning but within a predetermined signal strength threshold for data communication.

17. The node according to claim 10, wherein the node is adapted to transmit a wake up message to the device prior to sending the position request or the graphic information to the device.

18. A method performed in a device in a positioning system, wherein device is adapted for wireless communication with a node in the positioning system, the method comprising
receiving a position request from the node,
transmitting a position response to the node, and
receiving graphic information from the node, wherein the method further comprises
statically displaying said graphic information on an electronic ink display arranged on the device.

19. A method performed in a node in a positioning system wherein the node is adapted for wireless communication with a device in the positioning system, the method comprises
transmitting a position request to the device,
receiving a position response from the device,
calculating the distance to the device, and
transmitting graphic information to the device,
wherein the method further comprises
adapting said graphic information to be statically displayed on an electronic ink display arranged on the device.

20. A positioning system comprising
a node according to claim 10, and
a device adapted for wireless communication with the node, wherein the device is adapted to receive a position request from the node, transmit a position response to the node, and receive graphic information from the node, wherein the device further is adapted to statically display said graphic information on an electronic ink display arranged on the device.
